(19) United States
(12) Patent Application Publication
(10) Pub. No.: US 2020/0349050 A1
(43) Pub. Date: Nov. 5, 2020

(54) METHOD AND SYSTEM FOR ESTIMATING TRACE OPERATOR FOR A MACHINE LEARNING TASK

(71) Applicant: 1QB INFORMATION TECHNOLOGIES INC., Vancouver (CA)

(72) Inventors: Roohollah GHOBADI, Richmond (CA); Jaspreet S. OBEROI, Maple Ridge (CA); Ehsan ZAHEDINEJAD, Richmond (CA)

(73) Assignee: 1QB INFORMATION TECHNOLOGIES INC., Vancouver (CA)

(21) Appl. No.: 16/864,950

(22) Filed: May 1, 2020

Related U.S. Application Data
(60) Provisional application No. 62/842,208, filed on May 2, 2019.

(51) Int. Cl. G06F 11/34; G06N 10/00; G06N 3/08; G06N 20/10; G06K 9/62

(52) U.S. Cl. CPC G06F 11/3466; G06N 10/00; G06K 9/6215; G06N 20/10; G06N 3/084

(57) ABSTRACT

A method and a system are disclosed for estimating a trace operator to be used in a machine learning task. The method comprises obtaining an indication of a pair of points; constructing a quantum circuit comprising a single control qubit and a plurality of register qubits using the obtained pair of points, the constructing comprising receiving an encoding pattern and an architecture of a quantum circuit, encoding the pair of points into the plurality of register qubits, initializing the quantum circuit, and compiling the quantum circuit for a quantum device; evolving the quantum circuit on the quantum device; obtaining an indication of at least one measurement on the single control qubit of the corresponding quantum circuit; determining an indication of an estimated trace of the unitary operator representing the plurality of register qubits using the obtained indication of at least one measurement on the single control qubit and providing the indication of the estimated trace of the unitary operator.

### CROSS-REFERENCE TO RELATED APPLICATIONS

This application claims the benefit of US Provisional Patent Application No. 62/842,208, filed May 2, 2019, which is hereby incorporated by reference.

### FIELD OF THE INVENTION

One or more embodiments of the invention are directed towards estimation of trace operator using quantum device. In particular, they enable an estimation of classically intractable kernel functions and efficiently training of quantum neural networks. One or more embodiments of the method disclosed herein may be implemented on both universal quantum computers as well as presently available noisy intermediate-scale quantum (NISQ) devices, involving tens to hundreds of qubits.

### BACKGROUND OF THE INVENTION

### Kernel Method

Kernel method is used for applications in supervised or unsupervised machine learning.

For a classification task, the training (labeled) data Xₜᵣₐᵢₙ→{+1, −1} is used for finding a classifier f which can, with high probability, predict the correct label of unseen (test) data points Xₜₑₛₜ (i.e., f:Xₜₑₛₜ→{+1, −1}). A crucial step for this task is to define a similarity measure between the data points so that similar data points are assigned similar labels. This is done by defining the feature map Φ:X→ [symbol] where [symbol] is a Hilbert space and defining the kernel function as the inner product of the feature maps K(\vec{x}, \vec{x}′)= [symbol] Φ(\vec{x})|Φ(\vec{x}′) [symbol] for x, x′ ∈ X. The link between the kernel and learning has been established by the representer theorem which guarantees that for positive semi-definite kernel, the classifier can be written as f(\vec{x})=Σᵢαᵢ K(\vec{x}, \vec{x}ᵢ), where αᵢ ∈ [symbol] , \vec{x} ∈ Xₜₑₛₜ and \vec{x}ᵢ ∈ Xₜᵣₐᵢₙ (see also Schuld, M. & Killoran, N. Quantum machine learning in feature hilbert spaces.arXiv preprint arXiv:1803.07128(2018)).

### Support Vector Machine

An example of a kernel-based machine learning method for supervised machine learning may be support vector machines (SVMs). Assume a set of training (Xₜᵣₐᵢₙ) and test (Xₜₑₛₜ) dataset where X=(Xₜᵣₐᵢₙ ∪ Xₜₑₛₜ) ⊂ [symbol] ^{d}. Each data point \vec{x} ∈ X is assigned a label through a map s:X→{+1, −1}. The classification task is to use the training (labeled) data Xₜᵣₐᵢₙ→{+1, −1}, to find a classifier f which can with high probability predict the correct label of the unseen (test) data points Xₜₑₛₜ (i.e. f:Xₜₑₛₜ→{+1, −1}).

For the simple case of linearly separable classes, one can find a hyperplane, f(x)=sign(\vec{w}·\vec{x}+b), where \vec{w} and b are the hyperplane normal vector and offset respectively, which need to be determined using the training data. The distance between the hyperplane and the nearest data points (known as support vectors) from either class is known as the margin and an optimal hyperplane is the one with maximum margin from these support vectors. The classification problem is thus reduced to maximizing the margin (which is proportional to ∥\vec{w}∥⁻²) between the hyperplane and support vectors subject to the condition yᵢ(\vec{w}·\vec{x}ᵢ+b)≥1. It is possible to rewrite the classifier in terms of Lagrange multiplier as f(\vec{x})=sign (Σᵢ αᵢ yᵢ\vec{x}^{T}·\vec{x}ᵢ). The dependence of the classifier function on the data points is represented through their inner product. This feature is the basis of the kernel method and offers the framework for generalization of SVMs to nonlinear classifiers.

### Kernel Method for Quantum Machine Learning

The kernel method has been extended to quantum domain by defining the feature map as a map between the dataset and the space of density states as Φ:\vec{x}→|Φ(\vec{x}) [symbol] [symbol] Φ(\vec{x})| where |Φ(\vec{x}) [symbol] =U_{ϕ(\vec{x})}|0 [symbol] ^{⊗n}, where U_{ϕ(\vec{x})} is the unitary operator which acts on n number of qubits and ϕ(\vec{x}) is an encoding pattern. The kernel can then be defined as K(\vec{x}, \vec{x}′)= [symbol] Φ(\vec{x})|Φ(\vec{x}′) [symbol] ².

Deterministic Quantum Computing with One Qubit

The deterministic quantum computing with one qubit (DQC1) (Knill, Emanuel, and Raymond Laflamme. “Power of one bit of quantum information.” Physical Review Letters 81.25 (1998): 5672.) model is a non-universal quantum computing model which provides an exponential speeding up in estimating the normalized trace of a unitary matrix, independent of size of the matrix, over classical computing resources. The model defies the common notion that achieving a quantum advantage in computation requires pure states and quantum entanglement as a resource. In DQC1 circuit, the initial state |0 [symbol] [symbol] 0|⊗ρₙ evolves under the unitary interaction

uU=|0 [symbol] [symbol] 0|⊗ [symbol] ₙ+|1 [symbol] [symbol] 1|⊗Uₙ,

with [symbol] ₙ as the 2ⁿ×2ⁿ identity matrix. The final state (ρ_{f}) of the control single qubit becomes

$${ρ}_{f} = \frac{1}{2} ( \begin{matrix}1 & T r ( {ρ}_{n} {U}_{n} ) \\ T r ( {ρ}_{n} {U}_{n}^{†} ) & 1\end{matrix} ) .$$

where Tr refers to the trace operator.

In the special case where

$${ρ}_{n} = \frac{{n}_{}}{N} ( N = {2}^{n} ) ,$$

the off-diagonal terms become

$$\frac{1}{N} T r ( {U}_{n} ) .$$

It can be seen tnat the above argument is valid independent of the size of Uₙ. By measuring the Pauli operators, one gets

$$( {σ}_{x} 〉 = \frac{1}{N} Re [ T r ( {U}_{n} ) ] and 〈 {σ}_{y} 〉 = \frac{{n}_{}}{N} Im [ T r ( {U}_{n} ) ] .$$

The efficient estimation of the trace of an arbitrary large matrix is remarkable because estimating the trace of a matrix using a classical computer is an exponentially hard task.

### NISQ—Noisy Intermediate-Scale Quantum

The term Noisy Intermediate-Scale Quantum (NISQ) was introduced by Preskill, John, in “Quantum Computing in the NISQ era and beyond.” Quantum 2 (2018): 79. Here, “Noisy” implies that we have incomplete control over the qubits and the “Intermediate-Scale” refers to the number of qubits which ranges from 50 to a few hundreds. Several studies indicate that with NISQ technologies the performance of the classical computing devices can be surpassed for some specific tasks like machine learning or quantum chemistry. See for example Abrams, Daniel S., and Seth Lloyd. “Quantum algorithm providing exponential speed increase for finding eigenvalues and eigenvectors.” Physical Review Letters 83.24 (1999): 5162 or Havlíček, Vojtěch, et al. “Supervised learning with quantum-enhanced feature spaces.” Nature 567.7747 (2019): 209. Several physical systems such as superconducting artificial atoms, ion traps are proposed so far as feasible candidates to build universal quantum computer in general as well as NISQ quantum device.

### Classical Artificial Neural Networks (ANNs)

Artificial neural network is a computational framework to perform machine learning on big data. Providing enough examples (data), the network “learns” to perform some specific tasks without explicitly written rules for the network. A simple example is to train an ANNs to distinguish the pictures of cat from dog, providing enough pictures for the network to learn.

Graphically ANNs may be represented by a graph wherein each node is called a neuron and edges are called the weights of the ANNs or the learning parameters. While each neuron carries a float number, some nonlinear operation is applied on the output of each neuron to enable the network to learn more complicated pattern. An example of such nonlinear function is a Rectified Linear Unit (ReLU). To boost the learning ability of the network, in practice multiple layers of the neurons are stacked to form a deep network. The first layer is called the input layer and the last layer is called the output layer. Layers in between are called hidden layers. After defining the overall structure of the network (e.g., number of hidden layers, types of nonlinear functions which act on neurons, etc.) the learning of an ANNs for a specific task goes as follows:

Each data sample is fed one by one into the network and the values of the neurons in the output layer are computed.

A loss metric representing the performance of the ANNs on the machine learning task is evaluated. For example, for the case of a classification the metric may be Cross-Entropy loss function.

To gradually improve the performance of the ANNs the derivative of the loss metric with respect to the weights of the network is computed.

A backpropagation operation is performed, meaning the error of the learning model is propagated backward and the weights of the network are updated such that the overall loss metric of the network is optimized.

The above four steps continue until the performance of the network on the machine learning task is satisfactory. For detailed information on the classical neural network see Goodfellow, Ian, Yoshua Bengio, and Aaron Courville. Deep learning. MIT press, 2016.

### Quantum Artificial Neural Networks

Quantum Neural Networks (QNNs) are framework, systems or computation devices that benefit from the feature of quantum mechanics and artificial neural network. For a detailed background see Schuld, Maria, Ilya Sinayskiy, and Francesco Petruccione. “The quest for a quantum neural network.” Quantum Information Processing 13.11 (2014): 2567-2586.

The element of the QNNs may be explained by analogy with the elements of classical ANNs, i.e., neurons and learning parameter. A qubit may be considered as a quantum counterpart of a neuron and is called a quantum neuron. The learning parameters in a QNNs are the parameters of the quantum gates that construct the overall network of a QNNs. To train a QNNs to perform a specific machine learning task, the following steps may be taken:

Each data sample is fed one by one into the quantum network. This may be done by either encoding each sample into the initial state of the quantum network or into the parameters of the quantum gates.

For each system, the quantum circuit is evolved and the state of a subset of the qubits after the evolution is measured. This step is repeated multiple times to collect enough statistics about each qubit.

A loss metric representing the performance of the QNNs on the machine learning task is evaluated. For example, for the case of a classification the metric may be Cross-Entropy function.

To gradually improve the performance of the QNNs, the derivative of the loss metric with respect to the weights of the network is estimated. The quantum circuits corresponding to the gradient of the loss metric with respect to each of the learning parameters are constructed.

A backpropagation operation is performed meaning, the error of the learning model is propagated backward and the weights of the network are updated such that the overall loss metric of the network is optimized.

The above five steps continue until the performance of the network on the machine learning task is satisfactory.

### SUMMARY OF THE INVENTION

According to a broad aspect, there is disclosed a method for estimating a trace operator to be used in a machine learning task, the method comprising obtaining an indication of a pair of points; constructing a quantum circuit comprising a single control qubit and a plurality of register qubits using the obtained pair of points, the constructing comprising receiving an encoding pattern and an architecture of a quantum circuit, encoding the pair of points into the plurality of register qubits, initializing the quantum circuit, and compiling the quantum circuit for a quantum device; evolving the quantum circuit on the quantum device; obtaining an indication of at least one measurement on the single control qubit of the corresponding quantum circuit; determining an indication of an estimated trace of the unitary operator representing the plurality of register qubits using the obtained indication of at least one measurement on the single control qubit; and providing the indication of the estimated trace of the unitary operator.

According to one or more embodiments, the method further comprises determining if a number of measurements is sufficient and performing another measurement of the single control qubit of a corresponding quantum circuit if the number of measurements is not sufficient.

According to one or more embodiments, the machine learning task comprises a kernel-based machine learning task, each point is a data point of a dataset, and the trace of the unitary operator is indicative of corresponding kernel function used for obtaining an indication of a similarity measure between each data point of the pair of data points.

According to one or more embodiments, each point of the pair points is one of a data point of a data set and a vector of at least one neural network learning parameter of a neural network, and a mathematical function of the estimated trace of the unitary operator is used for computing an output of a quantum neural network.

According to one or more embodiments, an underlying task of the kernel-based machine learning task is classification.

According to one or more embodiments, an underlying task of the kernel-based machine learning task is regression.

According to one or more embodiments, an underlying task of the kernel-based machine learning task is clustering.

According to one or more embodiments, the quantum neural network is used as a classifier.

According to one or more embodiments, the quantum neural network is used as a regressor.

According to one or more embodiments, the quantum neural network is used as a Q-function in reinforcement learning.

According to a broad aspect, there is disclosed a non-transitory computer readable storage medium is disclosed for storing computer-executable instructions which, when executed, cause a computer to perform a method for estimating a trace operator to be used in a machine learning task, the method comprising obtaining an indication of a pair of points; constructing a quantum circuit comprising a single control qubit and a plurality of register qubits using the obtained pair of points, the constructing comprising receiving an encoding pattern and an architecture of quantum circuit, encoding the pair of points into the plurality of register qubits, initializing the quantum circuit, and compiling the quantum circuit for a quantum device; evolving the quantum circuit on the quantum device; obtaining an indication of at least one measurement on the single control qubit of the corresponding quantum circuit; determining an indication of an estimated trace of the unitary operator representing the plurality of register qubits using the obtained indication of at least one measurement on the single control qubit; and providing the indication of the estimated trace of the unitary operator.

According to a broad aspect, there is disclosed a computer comprising a central processing unit; a display device; a communication port for operatively connecting the computer with a quantum device; a memory unit comprising an application for estimating a trace operator for a machine learning task, the application comprising instructions for obtaining an indication of a pair of points; instructions for constructing a quantum circuit comprising a single control qubit and a plurality of register qubits using the obtained pair of points, the constructing comprising receiving an encoding pattern and an architecture of quantum circuit, encoding the pair of points into the plurality of register qubits, initializing the quantum circuit, and compiling the quantum circuit for the quantum device; instructions for evolving the quantum circuit on the quantum device; instructions for obtaining an indication of at least one measurement on the single control qubit of the corresponding quantum circuit; instructions for determining an indication of an estimated trace of the unitary operator representing the plurality of register qubits using the obtained indication of at least one measurement on the single control qubit; and instructions for providing the indication of the estimated trace of the unitary operator.

According to one to more embodiments, there is disclosed a system comprising the computer disclosed above and the quantum device operatively connected to the computer.

An advantage of one or more embodiments of the method and the system disclosed herein is that they have the potential of characterizing quantum advantage in machine learning tasks

Another advantage of one or more embodiments of the method and the system disclosed herein is that they are agnostic with respect to the underlying physical system that constructs the quantum computer.

Another advantage of one or more embodiments of the method and the system disclosed herein is that they may be used in any kernel-based machine learning algorithms and they are faster than any known method using classical computing device.

Another advantage of one or more embodiments of the method and the system disclosed herein is that they may be implemented either on a universal or Noisy Intermediate-Scale Quantum device.

Another advantage of one or more embodiment of the method and the system disclosed herein is that they may be used in a quantum neural network setting wherein the parameters of the quantum circuit are the learning parameters.

Another advantage of one or more embodiments of the method and the system disclosed herein is that they rely on quantum superposition and quantum correlations and may unveil hidden correlations among features in big data more effectively than the classical counterparts.

Another advantage of one or more embodiments of the method and the system disclosed herein is that they may be used as a function approximator in Q-learning.

Another advantage of one or more embodiments of the method and the system disclosed herein is that they may be used in unsupervised machine learning tasks such as clustering algorithm.

### BRIEF DESCRIPTION OF THE DRAWINGS

In order that the invention may be readily understood, embodiments of the invention are illustrated by way of example in the accompanying drawings.

FIG. 1 is a diagram that shows an embodiment of a system comprising a digital system coupled to an NISQ computer.

FIG. 2 is a flowchart that shows an embodiment of a method for estimating the trace operator using the system shown in FIG. 1.

FIG. 3 is a flowchart that shows an embodiment of a method for constructing a quantum circuit used in the estimation method shown in FIG. 2.

FIG. 4 is a flowchart that shows an embodiment of a method for training an SVM using the estimation method shown in FIG. 2.

FIG. 5 is a flowchart that shows an embodiment of a method for estimating kernel matrix used in training an SVM shown in FIG. 4.

FIG. 6 is a flowchart that shows an embodiment of a method for training a QNN using the estimation method shown in FIG. 2.

FIG. 7 is a flowchart that shows an embodiment of a method for parameters update used in training a QNN shown in FIG. 6.

FIG. 8 is a diagram that shows (a) the quantum circuit to perform DQC1; (b) the quantum circuit to construct the kernel circuit for two samples; (c) the circuit structure of unitary operation.

FIG. 9 is a diagram that shows (a) the general idea of using the QNNs where the parameters of the quantum circuit are iteratively updated through a learning procedure; (b) an example of the operator Uₙ(\vec{x}, θ) for the case of the two-dimensional dataset; (c) an example of the quantum circuit to estimate the gradient of the loss function.

Further details of one or more embodiments of the invention and its advantages will be apparent from the detailed description included below.

### DETAILED DESCRIPTION OF THE INVENTION

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an,” “the” and “at least one” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “analog computer” means a system comprising a quantum processor, control systems of qubits, coupling devices, and a readout system, all connected to each other through a communication bus.

Neither the Title nor the Abstract is to be taken as limiting in any way as the scope of the disclosed invention(s). The title of the present application and headings of sections provided in the present application are for convenience only and are not to be taken as limiting the disclosure in any way.

Numerous embodiments are described in the present application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

It will be appreciated that one or more embodiments of the invention may be implemented in numerous ways. In this specification, these implementations, or any other form that the invention may take, may be referred to as systems or techniques. A component such as a processor or a memory described as being configured to perform a task includes either a general component that is temporarily configured to perform the task at a given time or a specific component that is manufactured to perform the task.

With all this in mind, one or more embodiment the present invention is directed to a method and a system for estimating the trace operator for a machine learning task. It will be appreciated that the machine learning task may be of various types as further explained below.

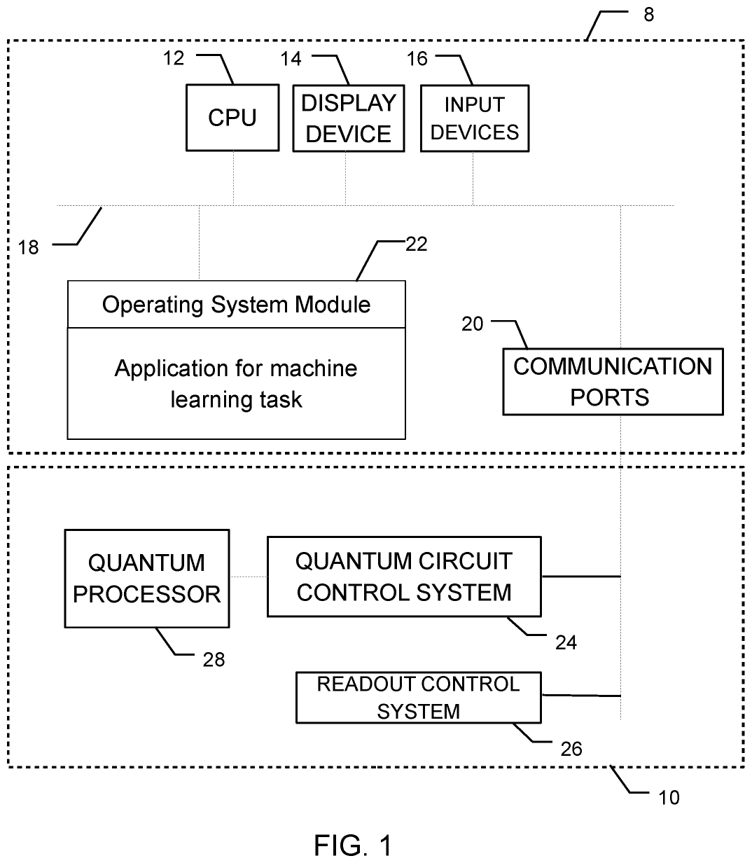

Now referring to FIG. 1, there is shown a diagram that shows an embodiment of a system comprising a digital system 8 coupled to a quantum device 10.

It will be appreciated that the digital computer 8 may be any type of digital computer.

In one embodiment, the digital computer 8 is selected from a group consisting of desktop computers, laptop computers, tablet PC's, servers, smartphones, etc. It will also be appreciated that, in the foregoing, the digital computer 8 may also be broadly referred to as a processor.

In the embodiment shown in FIG. 1, the digital computer 8 comprises a central processing unit 12, also referred to as a microprocessor, a display device 14, input devices 16, communication ports 20, a data bus 18 and a memory 22.

The central processing unit 12 is used for processing computer instructions. The skilled addressee will appreciate that various embodiments of the central processing unit 12 may be provided.

In one embodiment, the central processing unit 12 comprises a CPU Core i5 3210 running at 2.5 GHz and manufactured by Intel™.

The display device 14 is used for displaying data to a user. The skilled addressee will appreciate that various types of display device 14 may be used.

In one embodiment, the display device 14 is a standard liquid crystal display (LCD) monitor.

The input devices 16 are used for inputting data into the digital computer 8.

The communication ports 20 are used for sharing data with the digital computer 8.

The communication ports 20 may comprise, for instance, universal serial bus (USB) ports for connecting a keyboard and a mouse to the digital computer 8.

The communication ports 20 may further comprise a data network communication port, such as IEEE 802.3 port, for enabling a connection of the digital computer 8 with a quantum device 10.

The skilled addressee will appreciate that various alternative embodiments of the communication ports 20 may be provided.

The memory unit 22 is used for storing computer-executable instructions.

The memory unit 22 may comprise a system memory such as a high-speed random-access memory (RAM) for storing system control program (e.g., BIOS, operating system module, applications, etc.) and a read-only memory (ROM).

It will be appreciated that the memory unit 22 comprises, in one embodiment, an operating system module.

It will be appreciated that the operating system module may be of various types.

In one embodiment, the operating system module is OS X Yosemite manufactured by Apple™.

The memory unit 22 further comprises an application for training a machine learning model implemented in the quantum processor 28 of the quantum device 10.

The memory unit 22 may further comprise an application for using the quantum device 10, not shown.

The memory unit 22 may further comprise quantum processor data, not shown, such as a corresponding input data, encoding pattern of the input data into single- and two-qubit gates in the quantum processor 28.

The memory unit 22 may further comprise memory unit comprising an application for estimating a trace operator.

The application for estimating a trace operator comprises instructions for obtaining an indication of a pair of points. The application for estimating a trace operator further comprises instructions for constructing a quantum circuit comprising a single control qubit and a plurality of register qubits using the obtained pair of points, the constructing comprising receiving an encoding pattern and an architecture of quantum circuit, encoding the pair of points into the plurality of register qubits, initializing the quantum circuit, and compiling the quantum circuit for the quantum device. The application for estimating a trace operator further comprises instructions for evolving the quantum circuit on the quantum device. The application for estimating a trace operator further comprises instructions for obtaining an indication of at least one measurement on the single control qubit of the corresponding quantum circuit. The application for estimating a trace operator further comprises instructions for determining an indication of an estimated trace of the unitary operator representing the plurality of register qubits using the obtained indication of at least one measurement on the single control qubit. The application for estimating a trace operator further comprises instructions for providing the indication of the estimated trace of the unitary operator.

The quantum device 10 comprises a quantum circuit control system 24, a readout control system 26 and a quantum processor 28.

The quantum processor 28 may be of various types. In one embodiment, the quantum processor 28 comprises superconducting qubits.

The readout control system 26 is used for reading the qubits of the quantum processor 28. In fact, it will be appreciated that in order for a quantum processor to be used in the method disclosed herein, a readout system that measures the qubits of the quantum system in their quantum mechanical states is required. Multiple measurements provide a sample of the states of the qubits. The results from the readings are fed to the digital computer 8. The quantum circuit structure is controlled via quantum circuit control system 24.

It will be appreciated that the readout control system 26 may be of various types. For instance, the readout control system 26 may comprise a plurality of dc-SQUID magnetometers, each inductively connected to a different qubit of the quantum processor 28. The readout control system 26 may provide voltage or current values. In one embodiment, the dc-SQUID magnetometer comprises a loop of superconducting material interrupted by at least one Josephson junction, as is well known in the art.

### Power of One Qubit for Machine Learning

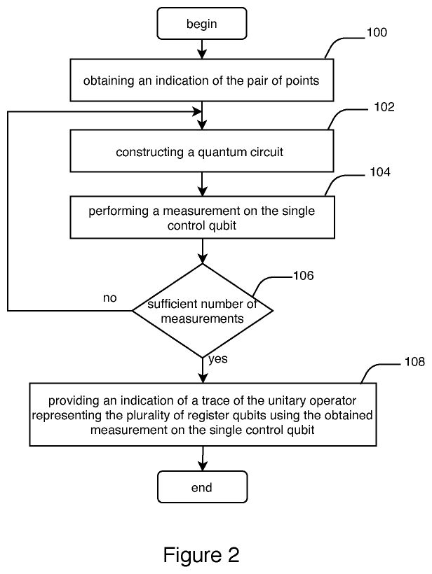

Now referring to FIG. 2, it will be appreciated that in one embodiment the system shown in FIG. 1 is used for estimating the trace operator.

Still referring to FIG. 2 and according to processing step 100, an indication of a pair of points is obtained.

In one embodiment, the pair of points comprises a pair of data points from a dataset X.

In another embodiment, the pair of points comprises a data point from a dataset X and neural network learning parameters (i.e. weights).

It will be appreciated that the indication of the pair of points may be obtained according to various embodiments.

According to the processing step 102, a quantum circuit is constructed. It will be appreciated that the quantum circuit comprises a single control qubit and a plurality of register qubits.

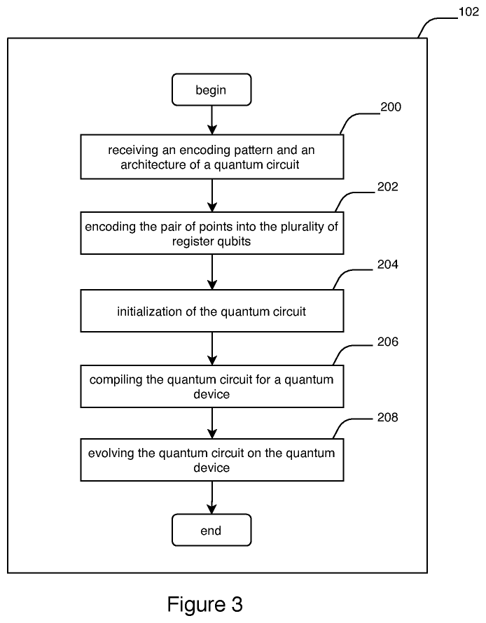

Now referring to FIG. 3, there is shown how the quantum circuit is constructed in accordance with an embodiment. According to processing step 200, an encoding pattern and an architecture of the quantum circuit are received.

According to processing step 202, the pair of points is encoded into the plurality of register qubits.

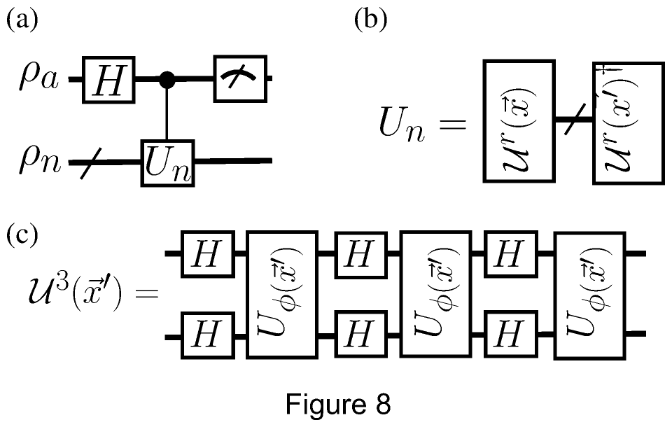

In fact, the pair of points may be encoded into a plurality of a register qubits (Uₙ) of a DQC1 quantum algorithm (see FIG. 8a).

In one embodiment, Uₙ is decomposed into a sequence of two unitary operators ( [symbol] ^{r}(\vec{x}) and [symbol] ^{r}(\vec{x}′)^{†}), each representing the encoding of an individual element of the pair (\vec{x}′ and \vec{x}) (see FIG. 8b) wherein r is the depth of the encoding circuit.

In one embodiment, [symbol] ᵣ(\vec{x})=Πᵢ₌₀^{r} [symbol] _{ϕ(\vec{x})}H^{⊗n} wherein H denotes the Hadamard gate and, [symbol] _{ϕ}(\vec{x})=exp(iΣ_{S}ϕ(\vec{x})_{S}Πᵢσ_{Z}ⁱ) wherein ϕ(\vec{x}) may be called the encoding pattern.

In the above embodiment, for the case of the two dimensional dataset the encoding pattern may be defined as ϕᵢ(\vec{x})=xᵢ, (i ∈ {1, 2}) and ϕ_{1,2}(\vec{x})=(π−x₁) (π−x₂).

In another embodiment, the depth of the encoding circuit (see FIG. 8c) may be chosen to be r=3.

It will be appreciated by the skilled addressee that the choice of encoding may be generalized to datasets with more than two dimensions. Any well-defined mathematical function may be used as an encoding choice for that purpose.

It will be further appreciated that the depth of the encoding circuit may be chosen from any integer number.

In one embodiment, Uₙ(\vec{x}, \vec{x}′)=D^{†}(\vec{x}′)D(\vec{x}), wherein D is the displacement operator.

Still in the same embodiment, if ρₙ=|0 [symbol] [symbol] 0|^{⊗n}, a well known radial basis function K(\vec{x}, \vec{x}′)=^{-|\vec{x}-\vec{x}′|2} may be obtained.

Still referring to FIG. 3 and according to processing step 204, the quantum circuit is initialized (see FIG. 8a).

In one embodiment, the initial state is a mixed state.

In another embodiment, the initial state is a pure state.

In another embodiment, the initial state is any well-defined quantum state.

In another embodiment, the initial state of the control qubit is

$$\frac{{2}_{} + β {σ}_{z}}{2} ,$$

wherein β ∈ [symbol] and σ_{z} denotes the Pauli-Z operator.

Still referring to FIG. 3 and according to processing step 206, the corresponding quantum circuit is compiled for the underlying quantum device unit 10.

According to processing step 208, the initialized quantum circuit is evolved on the quantum device unit 10.

Now referring back to FIG. 2 and according to processing step 104, a measurement is performed on the control qubit.

According to processing step 106, a test is performed in order to find out if a number of measurements is sufficient of not. It will be appreciated that in the embodiment wherein the initial state of the control qubit is a pure state, the rule that the number of measurements to collect from the control qubit is given by

$$O ( \frac{log ( \frac{1}{δ} )}{{ϵ}^{2}} )$$

to be within ϵ distance of accuracy δ may be followed.

With respect to the number of measurements, it will be appreciated that in the embodiment wherein the initial state of the control qubit is

$$\frac{{2}_{} + β {σ}_{z}}{2} ,$$

the rule that the number of measurements to collect from the control qubit is given by

$$O ( \frac{log ( \frac{1}{δ} )}{{ϵ}^{2} {β}^{2}} )$$

to be within ϵ distance of accuracy δ may be followed.

Still referring to FIG. 2 and according to processing step 106, if the required number of measurements is not reached, then the processing steps 102 and 104 are repeated.

In the case where the required number of measurements is reached and according to processing step 108 an indication of a trace of the unitary operator representing the plurality of register qubits is provided using the obtained measurement on the single control qubit.

In one embodiment, the trace operator is the kernel K(\vec{x}, \vec{x}′)=Tr(ρₙ [symbol] ^{†}(\vec{x}′) [symbol] (\vec{x})) of the two elements of the data points (\vec{x}′ and \vec{x}).

In another embodiment, the trace is the output (quantum neuron) of the quantum neural network.

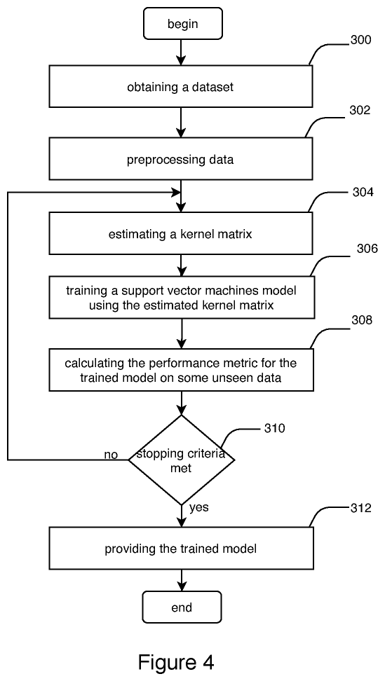

It will be appreciated that in one embodiment, the trace operator estimation may be used in the SVMs model as shown in FIG. 4. In fact, it will be appreciated that in this embodiment, the machine learning task comprises a kernel-based machine learning task wherein, as further explained below, each point is a data point of a dataset and wherein the trace of the unitary operator is indicative of corresponding kernel function used for obtaining an indication of a similarity measure between each data point of the pair of data points. It will be appreciated that in one embodiment, an underlying task of the kernel-based machine learning task is classification. In another embodiment, an underlying task of the kernel-based machine learning task is regression. In another embodiment, an underlying task of the kernel-based machine learning task is clustering.

Now referring to FIG. 4 and according to processing step 300, a dataset X is obtained. It will be appreciated that the dataset X may be obtained according to various embodiments.

Still referring to FIG. 4 and according to processing step 302, the data of the dataset X is preprocessed. It will be appreciated that, for instance, the data may be normalized or augmented.

According to processing step 304, a kernel matrix is estimated.

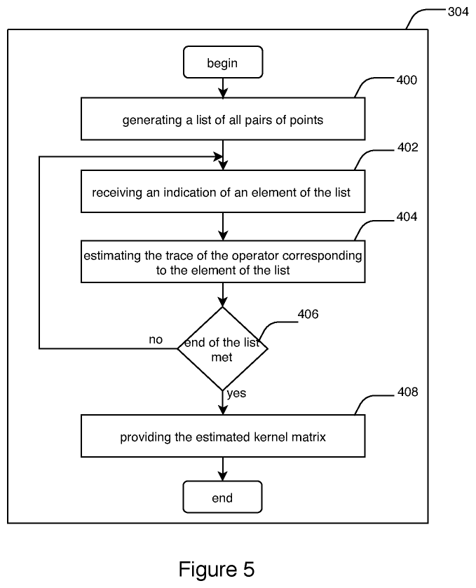

Now referring to FIG. 5, there is shown an embodiment for estimating the kernel matrix.

According to processing step 400, given a dataset X, a list of pairs of data points is generated.

According to processing step 402, an indication of an element of the list of pairs of data points is received.

According to processing step 404, the trace corresponding to the operator representing the pair of points is estimated according to the method disclosed in FIG. 2.

It will be appreciated that, in this embodiment, the trace related to the kernel K(\vec{x}, \vec{x}′) of the two points (\vec{x}′ and \vec{x}) is defined via Tr(ρₙ [symbol] ^{†}(\vec{x}′) [symbol] (\vec{x})) where ρₙ is the initial state of the plurality of the register qubits.

It will be appreciated that for the case of the ρₙ=|0 [symbol] [symbol] 0|^{⊗n}, the final state of the control qubit is

$${ρ}_{f} = \frac{1}{2} ( \begin{matrix}1 & K ( x , {x}^{′} ) \\ {K}^{*} ( \vec{x} , {\vec{x}}^{′} ) & 1\end{matrix} ) .$$

Still referring to FIG. 5 and according to processing step 406, a test is performed in order to find out if the end of the list of pairs of data points is reached or not.

In the case where the end of the list of pairs of data points is not reached, processing step 402 and 404 are repeated.

In the case wherein the end of the list of pairs of data points is reached and according to processing step 408, the estimated kernel matrix is provided.

Now referring back to FIG. 4 and according to processing step 306, a classical SVMs model is trained using the estimated kernel matrix.

According to processing step 308, a performance metric representing the performance of the trained model on some unseen data is calculated.

In one embodiment wherein the underlying task is classification, the performance metric is precision.

In another embodiment wherein the underlying task is regression, the performance metric is R² score.

It will be appreciated that other performance metric may be considered according to the underlying machine learning task.

Still referring to FIG. 4, according to the processing step 310, a test is performed in order to find out if a stopping criterion is met. It will be appreciated that the stopping criterion may be of various types. In one embodiment, the stopping criterion is a performance criterion.

It will be appreciated that processing units 304, 306, 308 are repeated in the case where the stopping criterion is not met.

In the case where the stopping criterion is met and according to processing step 312, a trained SVM model using the provided quantum kernel is provided.

In one embodiment, wherein the underlying task is a classification problem the criterion may be to reach 99% classification accuracy. In this embodiment, the decision is “Yes” if the performance metric of the trained model on the unseen data is higher than 99%, otherwise the decision is “No.”

It will be further appreciated by the skilled addressee that various criteria may be considered depending on an application sought.

### Quantum Neural Networks

It will be appreciated that in another embodiment, the trace operator estimation may also be used in quantum neural networks (QNNs).

In fact, it will be appreciated that the quantum neural network may be used as a classifier in one embodiment. In another embodiment, the quantum neural network is used as a regressor. In another embodiment, the quantum neural network is used as a Q-function in reinforcement learning.

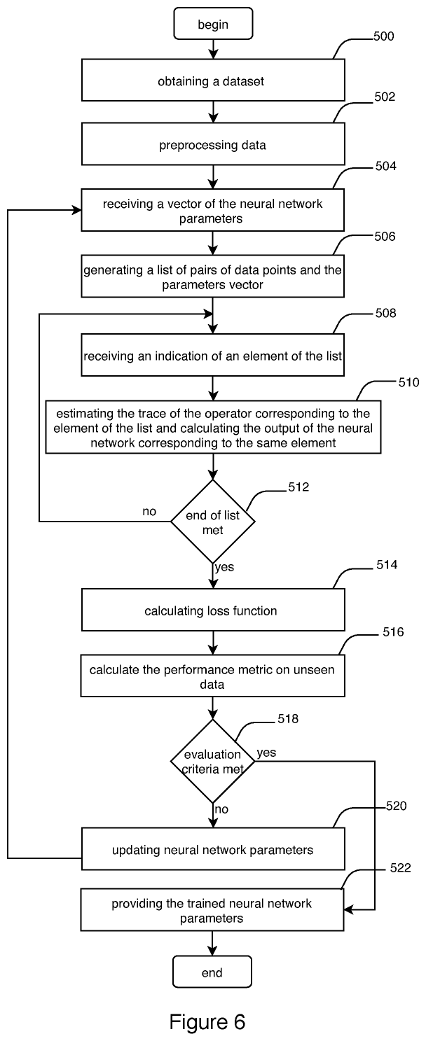

Now referring to FIG. 6 and according to processing step 500, a dataset X is obtained. It will be appreciated that the dataset X may be obtained according to various embodiments.

Still referring to FIG. 6 and according to processing step 502, the data of the dataset X is preprocessed. It will be appreciated that the data of the dataset X may be normalized or augmented, for instance.

Still referring to FIG. 6, according to processing step 504, a vector of the neural network parameters is received.

According to processing step 506, a list of pairs of data points (x ∈ X) and neural network parameters (θ) is generated. It will be appreciated that, in one embodiment, the list is generated such that for each element of the list, the first element is a data point and the second element is a vector of neural network parameters.

According to processing step 508, an indication of an element of the list of pairs of data points (x ∈ X) and neural network parameters (θ) is received.

Still referring to FIG. 6 and according to processing step 510, the trace corresponding to the operator representing the pair of points is estimated according to the method disclosed in FIG. 2. The trace estimation of the operator is used for calculating the output of the neural network.

In one embodiment, the calculating of the output of the neural network is performed by applying a sigmoid function on the real or imaginary part or on the whole trace value of the operator which represents the pair of the points.

In another embodiment, the calculating of the output of the neural network is performed by applying a Rectified Linear Unit (ReLU) on the real or imaginary part or on the whole trace value of the operator which represents the pair of the points.

It will be appreciated by the skilled addressee that any other mathematical function may be applied on the real or imaginary part or on the whole trace value of the operator which represents the pair of the points to calculate calculating the output of the neural network.

Still referring to FIG. 6 and according to the processing step 512, a test is performed in order to find out if the end of the list of pairs of data points (x ∈ X) and neural network parameters (θ) is reached or not.

It will be appreciated that processing steps 508 and 510 are repeated in the case where the end of the list of pairs of data points (x ∈ X) and neural network parameters (θ) is not reached.

In the case where the end of the list of pairs of data points (x ∈ X) and neural network parameters (θ) is reached and according to processing step 514, a loss function corresponding to the training performance of the QNNs is calculated.

In one embodiment, wherein the underlying machine learning task is classification, the loss function is the Cross-Entropy function

$$𝒦 ( θ ) = \frac{1}{M} {\sum }_{i = 1}^{M} [ {y}_{i} log ( f ( {\vec{x}}_{i} , θ ) ) + ( 1 - {y}_{i} ) ( 1 - log ( f ( {\vec{x}}_{i} , θ ) ) ) ] ,$$

wherein M is the size of the Xₜᵣₐᵢₙ and f(\vec{x}ᵢ, θ) is a mathematical function applied on the real or imaginary part or on the whole trace value of the operator which represents the pair of the points (\vec{x}ᵢ, θ).

In another embodiment wherein the underlying machine learning task is regression, the loss function is the Mean square error function.

It will be appreciated that any other loss function may be calculated according to the underlying machine learning task.

Still referring to FIG. 6 and according to processing step 516, a performance metric is calculated on unseen data.

In one embodiment, wherein the underlying machine learning task is classification, the performance metric is the accuracy.

In another embodiment, wherein the underlying machine learning task is regression the performance metric is the R² score.

It will be appreciated that the various types of the performance metric may be considered according to the machine learning task in hand.

Still referring to FIG. 6 and according to processing step 518, a test is performed in order to find out if an evaluation criterion is met.

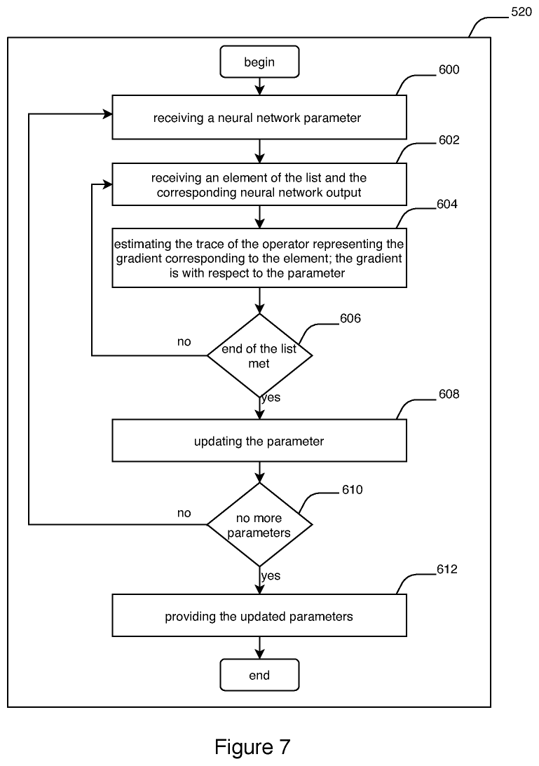

In the case where the evaluation criterion is not met and according to processing step 520, the vector of neural network parameters (θ) is updated as shown in FIG. 7. Steps 504, 506, 508, 510, 512, 514, 516, 518 are repeated.

In the case where the evaluation criterion is met and according to processing step 522, the trained neural network parameters are provided.

In one embodiment, wherein the underlying task is a classification problem, the evaluation criterion may be to reach 99% classification accuracy. In such embodiment, the decision is “Yes” if the performance metric of the trained model on the unseen data is higher than 99%, otherwise the decision is “No.”

It will be appreciated by the skilled addressee that various evaluation criteria may be used depending on the desired performance of the model.

Now referring to FIG. 7 and according to processing step 600, a neural network parameter is received.

According to processing step 602, an element of the list as well as the output of the neural network corresponding to the element of the list are received.

According to the processing step 604, the trace operator representing the gradient of loss function is estimated using the method disclosed in FIG. 2. The gradient is with respect to the parameter.

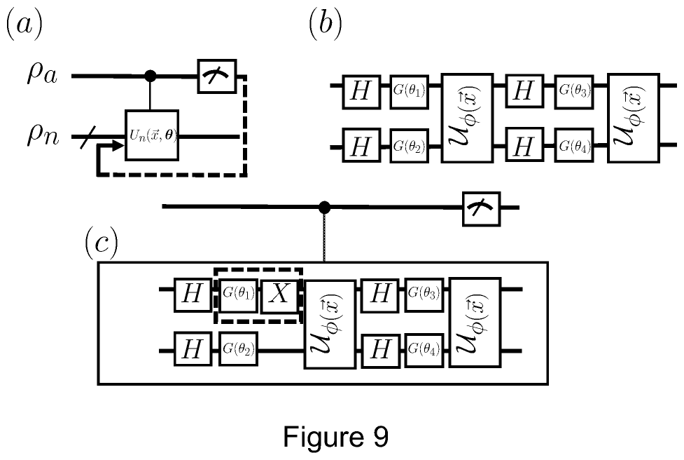

In one embodiment, each of the parameters of the neural network vector (θ) is encoded into a single-qubit gate G(θⱼ)=exp(−iPθⱼ) (j ∈ {1, ·, l}, wherein l is the number of learning parameters and P may be any of the Pauli's operators and given the encoding in FIG. 9b, a quantity proportional to the gradient for the loss-function related to a two-dimensional dataset is obtained (refer to FIG. 9c). The gradient for this specific case takes the form

$$\frac{\partial 𝒦 ( θ )}{\partial {θ}_{j}} = \frac{1}{M} {\sum }_{i = 1}^{M} \frac{\partial Re ( T r [ {U}_{n} ( θ , {\vec{x}}_{i} ) ] )}{\partial {θ}_{j}} ( {y}_{i} - f ( {\vec{x}}_{i} , θ ) ) ,$$

wherein the mathematical function applied on the real (Re) part of the trace operator (Uₙ(θ, \vec{x}ᵢ)), is a sigmoid function.

It will be appreciated that the above embodiment may be generalized to datasets in higher dimensions.

Still referring to FIG. 7 and according to processing step 606, a test is performed in order to find out if the end of the list is reached.

It will be appreciated that processing steps 602 and 604 are performed in the case where the end of the list is not reached.

In the case where the end of the list is reached and according to processing step 608, each parameter of the neural network is updated using a gradient descent update rule:

$${θ}_{j} = {θ}_{j} - α \frac{\partial 𝒦 ( θ )}{\partial {θ}_{j}} ,$$

wherein α is called the learning rate.

Still referring to FIG. 7 and according to processing step 610, a test is performed in order to find out if there is at least one parameter left to update.

Processing step 600 is performed in the case where there is at least one parameter left to update.

In the case where there is not at least one parameter left to update and according to processing step 612, the updated neural network parameters θ are provided.

Now referring back to FIG. 6 and according to processing step 522, the trained neural network parameters are provided. It will be appreciated that the trained neural network parameters may be provided according to various embodiments.

It will be appreciated that a non-transitory computer readable storage medium is further disclosed for storing computer-executable instructions which, when executed, cause a computer to perform a method for method for estimating a trace operator to be used in a machine learning task, the method comprising obtaining an indication of a pair of points; constructing a quantum circuit comprising a single control qubit and a plurality of register qubits using the obtained pair of points, the constructing comprising receiving an encoding pattern and an architecture of quantum circuit, encoding the pair of points into the plurality of register qubits, initializing the quantum circuit, and compiling the quantum circuit for a quantum device; evolving the quantum circuit on the quantum device; obtaining an indication of at least one measurement on the single control qubit of the corresponding quantum circuit; determining an indication of an estimated trace of the unitary operator representing the plurality of register qubits using the obtained indication of at least one measurement on the single control qubit; and providing the indication of the estimated trace of the unitary operator.

It will be appreciated that one or more embodiments of the method and the system disclosed herein are of great advantage for various reasons.

In fact, an advantage of one or more embodiments of the method and the system disclosed herein is that they have the potential of characterizing quantum advantage in machine learning tasks

Another advantage of one or more embodiments of the method and the system disclosed herein is that they are agnostic with respect to the underlying physical system that constructs the quantum computer.

Another advantage of one or more embodiments of the method and the system disclosed herein is that they may be used in any kernel-based machine learning algorithms and they are faster than any known method using classical computing device.

Another advantage of one or more embodiments of the method and the system disclosed herein is that they may be implemented either on a universal or Noisy Intermediate-Scale Quantum device.

Another advantage of one or more embodiment of the method and the system disclosed herein is that they may be used in a quantum neural network setting wherein the parameters of the quantum circuit are the learning parameters.

Another advantage of one or more embodiments of the method and the system disclosed herein is that they rely on quantum superposition and quantum correlations and may unveil hidden correlations among features in big data more effectively than the classical counterparts.

Another advantage of one or more embodiments of the method and the system disclosed herein is that they may be used as a function approximator in Q-learning.

Another advantage of one or more embodiments of the method and the system disclosed herein is that they may be used in unsupervised machine learning tasks such as clustering algorithm.

1. A method for estimating a trace operator to be used in a machine learning task, the method comprising:
obtaining an indication of a pair of points;
constructing a quantum circuit comprising a single control qubit and a plurality of register qubits using the obtained pair of points, the constructing comprising:
receiving an encoding pattern and an architecture of a quantum circuit,
encoding the pair of points into the plurality of register qubits,
initializing the quantum circuit, and
compiling the quantum circuit for a quantum device;
evolving the quantum circuit on the quantum device;
obtaining an indication of at least one measurement on the single control qubit of the corresponding quantum circuit;
determining an indication of an estimated trace of the unitary operator representing the plurality of register qubits using the obtained indication of at least one measurement on the single control qubit; and
providing the indication of the estimated trace of the unitary operator

2. The method as claimed in claim 1, further comprising determining if a number of measurements is sufficient, and further comprising performing another measurement of the single control qubit of a corresponding quantum circuit if the number of measurements is not sufficient.

3. The method as claimed in claim 1, wherein the machine learning task comprises a kernel-based machine learning task, further wherein each point is a data point of a dataset, further wherein the trace of the unitary operator is indicative of corresponding kernel function used for obtaining an indication of a similarity measure between each data point of the pair of data points.

4. The method as claimed in claim 1, wherein each point of the pair points is one of a data point of a data set and a vector of at least one neural network learning parameter of a neural network, further wherein a mathematical function of the estimated trace of the unitary operator is used for computing an output of a quantum neural network.

5. The method as claimed in claim 3, wherein an underlying task of the kernel-based machine learning task is classification.

6. The method as claimed in claim 3, wherein an underlying task of the kernel-based machine learning task is regression.

7. The method as claimed in claim 3, wherein an underlying task of the kernel-based machine learning task is clustering.

8. The method as claimed in claim 4, wherein the quantum neural network is used as a classifier.

9. The method as claimed in claim 4, wherein the quantum neural network is used as a regressor.

10. The method as claimed in claim 4, wherein the quantum neural network is used as a Q-function in reinforcement learning.

11. A non-transitory computer readable storage medium is disclosed for storing computer-executable instructions which, when executed, cause a computer to perform a method for estimating a trace operator to be used in a machine learning task, the method comprising:
obtaining an indication of a pair of points;
constructing a quantum circuit comprising a single control qubit and a plurality of register qubits using the obtained pair of points, the constructing comprising:
receiving an encoding pattern and an architecture of quantum circuit,
encoding the pair of points into the plurality of register qubits,
initializing the quantum circuit, and
compiling the quantum circuit for a quantum device;
evolving the quantum circuit on the quantum device;
obtaining an indication of at least one measurement on the single control qubit of the corresponding quantum circuit;
determining an indication of an estimated trace of the unitary operator representing the plurality of register qubits using the obtained indication of at least one measurement on the single control qubit; and
providing the indication of the estimated trace of the unitary operator.

12. A computer comprising:
a central processing unit;
a display device;
a communication port for operatively connecting the computer with a quantum device;
a memory unit comprising an application for estimating a trace operator for a machine learning task, the application comprising:
instructions for obtaining an indication of a pair of points;
instructions for constructing a quantum circuit comprising a single control qubit and a plurality of register qubits using the obtained pair of points, the constructing comprising:
receiving an encoding pattern and an architecture of quantum circuit,
encoding the pair of points into the plurality of register qubits,
initializing the quantum circuit, and
compiling the quantum circuit for the quantum device;
instructions for evolving the quantum circuit on the quantum device;
instructions for obtaining an indication of at least one measurement on the single control qubit of the corresponding quantum circuit;
instructions for determining an indication of an estimated trace of the unitary operator representing the plurality of register qubits using the obtained indication of at least one measurement on the single control qubit; and
instructions for providing the indication of the estimated trace of the unitary operator.

13. A system comprising:
the computer as claimed in claim 12; and the quantum device operatively connected to the computer.
